(19) United States
(12) Patent Application Publication
(10) Pub. No.: US 2026/0206090 A1
(43) Pub. Date: Jul. 16, 2026

(54) Methods And Apparatus For Performing Sensing Operation Under Radio Resource Control Mode In Mobile Communications

(71) Applicant: MediaTek Singapore Pte. Ltd., Singapore (SG)

(72) Inventors: Wenze Qu, Beijing (CN); Jianwei Zhang, Beijing (CN); Chiao-Yao Chuang, Hsinchu City (TW); Min Lei, Beijing (CN); Haoran Li, Beijing (CN); Xuanbo Shao, Beijing (CN); Tao Chen, Beijing (CN)

(73) Assignee: MediaTek Singapore Pte. Ltd., Singapore (SG)

(21) Appl. No.: 19/435,765

(22) Filed: Dec. 30, 2025

(30) Foreign Application Priority Data
Jan. 3, 2025 (WO) PCT/CN2025/070415
Dec. 17, 2025 (CN) 202511912325.1

(51) Int. Cl. H04W 76/27; H04W 76/28

(52) U.S. Cl. CPC H04W 76/27; H04W 76/28

(57) ABSTRACT

Various solutions for performing sensing operation under various Radio Resource Control (RRC) modes with respect to an apparatus in mobile communications are described. The apparatus may enter an RRC mode including an idle mode, an inactive mode or a connected mode. The apparatus may perform a sensing operation after entering the RRC mode.

### CROSS REFERENCE TO RELATED PATENT APPLICATION(S)

The present disclosure is part of a non-provisional application claiming the priority benefit of PCT Application No. PCT/CN2025/070415, filed on 3 Jan. 2025, and CN Application No. 202511912325.1, filed 17 Dec. 2025, the content of which herein being incorporated by reference in their entirety.

### TECHNICAL FIELD

The present disclosure is generally related to mobile communications and, more particularly, to performing sensing operation under various Radio Resource Control (RRC) modes with respect to apparatus in mobile communications.

### BACKGROUND

Unless otherwise indicated herein, approaches described in this section are not prior art to the claims listed below and are not admitted as prior art by inclusion in this section.

In New Radio (NR) mobile communications, Integrated Sensing and Communication (ISAC) systems have been developed. In particular, ISAC systems may enable simultaneous environmental sensing and wireless communication by reusing shared waveform resources (e.g., Orthogonal Frequency-Division Multiplexing (OFDM) signals).

In some scenarios, a sensing node (e.g., a User Equipment (UE)) in ISAC systems may be required to perform continuous or periodic sensing tasks while carrying only minimal communication data. However, maintaining the sensing node in a Radio Resource Control (RRC) connected mode solely for such limited communication data transmission may result in unnecessary power consumption and reduced efficiency in sensing-dominant operations.

Accordingly, how to reduce power consumption and improve efficiency in sensing-dominant operations under ISAC systems has become an important issue in the newly developed wireless communication network. Therefore, there is a need to reduce power consumption and improve efficiency in sensing-dominant operations under ISAC systems.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to performing sensing operation under various Radio Resource Control (RRC) modes with respect to apparatus in mobile communications.

In one aspect, a method may involve an apparatus entering a first RRC mode including an idle mode, an inactive mode or a connected mode. The method may further involve the apparatus performing a sensing operation after entering the first RRC mode.

In one aspect, a method may involve an apparatus transmitting at least one sensing configuration to configure another apparatus to perform a sensing operation under an RRC mode including an idle mode, an inactive mode or a connected mode. The method may further involve the apparatus performing the sensing operation.

In one aspect, an apparatus may comprise a transceiver which, during operation, wirelessly communicates with a wireless network. The apparatus may also comprise a processor communicatively coupled to the transceiver. The processor, during operation, may perform operations comprising entering an RRC mode including an idle mode, an inactive mode or a connected mode. The processor may further perform operations comprising performing a sensing operation after entering the RRC mode.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a diagram depicting an example scenario under schemes in accordance with implementations of the present disclosure.

FIG. 9 is a diagram depicting an example scenario under schemes in accordance with implementations of the present disclosure.

FIG. 10 is a block diagram of an example communication system in accordance with an implementation of the present disclosure.

FIG. 11 is a flowchart of an example process in accordance with an implementation of the present disclosure.

FIG. 12 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to performing sensing operation under various RRC modes with respect to apparatus in mobile communications. According to the present disclosure, a number of possible solutions may be implemented separately or jointly. That is, although these possible solutions may be described below separately, two or more of these possible solutions may be implemented in one combination or another.

First, it should be noted that, in an Integrated Sensing And Communication (ISAC) system, there may be one or more sensing apparatus. The sensing apparatus may include a transmitter (TX) and a receiver (RX). In some scenarios, the TX and RX may be either co-located or spatially separated. When the TX and RX are co-located, for example, within a common sensing apparatus, the system may be referred to as a monostatic sensing system. When the TX and RX are disposed at different locations, for example, within different sensing apparatus, the system may be referred to as a bistatic sensing system. It should be noted that the following disclosed techniques may be applied to either a monostatic sensing system or a bistatic sensing system.

Regarding the present disclosure, a sensing apparatus (e.g., an RX or a TX including a User Equipment (UE) or a Base Station (BS)), which may perform a sensing operation, may enter a first RRC mode. The first RRC mode may include an idle mode, an inactive mode or a connected mode. After entering the first RRC mode, the sensing apparatus may perform a corresponding sensing operation.

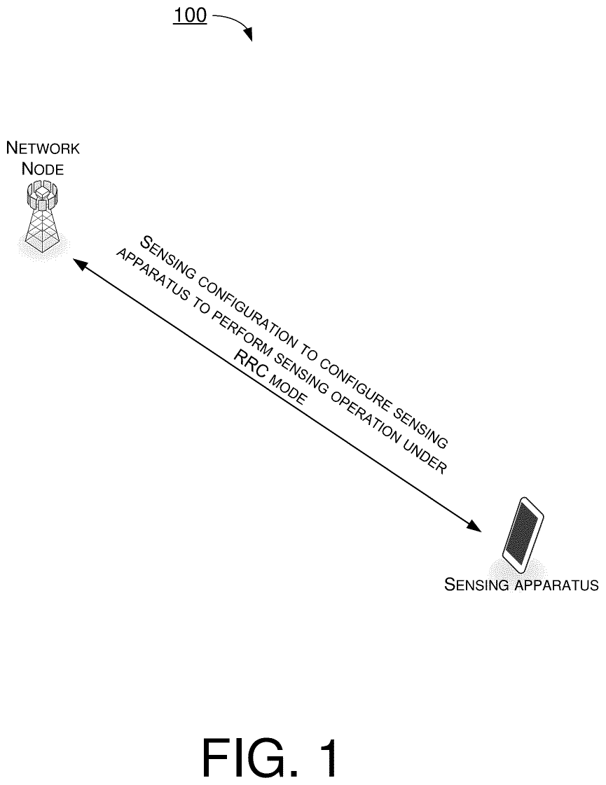

FIG. 1 illustrates an example scenario 100 under schemes in accordance with implementations of the present disclosure. In some embodiments, a network node (e.g., a UE or a BS having a sensing function) may transmit at least one sensing configuration to configure a sensing apparatus (e.g., an RX or a TX including a UE or a BS) to perform a sensing operation under an RRC mode. Based on the at least one sensing configuration, the sensing apparatus may enter a first RRC mode and perform a corresponding sensing operation with the network node.

In some implementations, the at least one sensing configuration may be received before entering the first RRC mode. The first RRC mode may include the idle mode or the inactive mode. Performing the sensing operation may include: (1) receiving a sensing signal under the first RRC mode, and (2) processing the sensing signal to generate sensing data under the first RRC mode. The sensing apparatus may enter a second RRC mode which may include a connected mode. The sensing apparatus may report the sensing data under the second RRC mode.

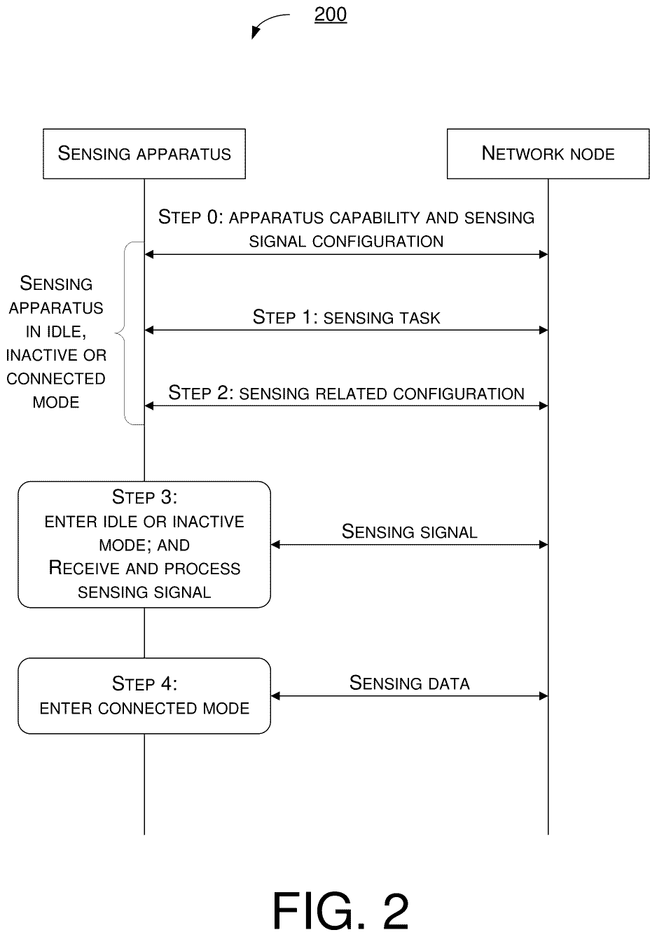

FIG. 2 illustrates an example scenario 200 under schemes in accordance with implementations of the present disclosure. In particular, there may be five main steps, which are steps 0 to 4, in a bistatic Downlink (DL) sensing procedure between the sensing apparatus and the network node (e.g., a UE-BS bistatic DL sensing procedure). During steps 0 to 2, the sensing apparatus may be under the idle mode, the inactive mode or the connected mode.

In step 0, the sensing apparatus may report apparatus capability and sensing signal configuration under the idle mode, the inactive mode or the connected mode. More specifically, the sensing apparatus may report to the network node that the sensing apparatus may support sensing operation in the idle mode, the inactive mode or the connected mode.

In some cases, sensing signal(s) used between the network node and the sensing apparatus may include: (1) a communication signal (e.g., Synchronization Signal Block (SSB) or Tracking Reference Signal (TRS)), or (2) a signal dedicated for sensing.

In some cases, the sensing signal(s) may be configured through System Information Block (SIB), RRC signaling, Media Access Control Control Element (MAC CE), Downlink Control Information (DCI), paging, Paging Early Indication (PEI), etc. The sensing signal configuration may include sensing signal period, time and frequency domain pattern, Bandwidth (BW), beam related information, etc. The sensing signal(s) may be enabled or validated (e.g., effective time) through SIB, RRC signaling, MAC CE, DCI, paging, PEI, etc. The sensing signal configuration and enabling/validation of the sensing signal may be exchanged under the idle mode, the inactive mode or the connected mode before the sensing apparatus and the network node start sensing operation.

In step 1, in an event that a sensing task is triggered by the network node, the sensing apparatus may participate in the sensing task (e.g., receiving a sensing signal, processing a sensing signal, calculating sensing data, and reporting the sensing data). In some cases, the sensing task may involve respiration detection or intrusion detection.

In step 2, the sensing related configuration may be transceived. More specifically, the network node may: (1) configure the sensing apparatus to perform sensing operation in the idle mode, the inactive mode or the connected mode, and/or (2) configure which signal (e.g., SSB, TRS or dedicated sensing signal) the sensing apparatus may be used to perform sensing operation.

In some cases, with respect to the sensing signal configuration and enabling/validation of sensing signal, (1) validation and some additional configuration information may be configured in step 2 (while part of configurations have been configured in step 0), or (2) the sensing signal configuration and enabling/validation of sensing signal may be fully configured in step 2.

In some cases, with respect to sensing measurement and reporting related information, the network node may: (1) configure the sensing apparatus with sensing task requirements (e.g., measurement quantities, quality requirement, periodicity, etc.), (2) configure what the sensing apparatus may report, including reporting quantities, reporting value format, reporting periodicity and type (periodic, aperiodic, semi-persistent, etc.), and/or (3) configure the sensing apparatus that, if there is sensing data required to be reported to the network node, the sensing apparatus may enter the connected mode.

In step 3, if there is no communication data transmission and reception requirement, the sensing apparatus may enter the first RRC mode which may be the idle mode or the inactive mode. Under the first RRC mode, the sensing apparatus may receive a sensing signal and process the sensing signal to generate sensing data. In some cases, processing the sensing signal to generate the sensing data may include: (1) using 2D-Fast Fourier Transform (2D-FFT) or Multiple Signal Classification (MUSIC) algorithm to estimate a target's delay, Doppler, or angle information, and/or (2) calculating micro-Doppler characteristics of the sensing signal to determine the target's respiration rate.

In step 4, if the sensing apparatus needs to report the sensing data to a network node, the sensing apparatus may enter the second mode, which may be the connected mode. The network node may receive the sensing data associated with the sensing signal. The reporting may be performed based on the configuration and requirements of step 2. In some cases, if the sensing apparatus does not need to report the sensing data to the network node and instead reports the data to a local higher layer of the sensing apparatus (e.g., a sensing application), the sensing apparatus may not need to enter the connected mode.

In some implementations, the at least one sensing configuration may be received before entering the first RRC mode. The first RRC mode may include the inactive mode. Performing the sensing operation may include: (1) receiving a sensing signal under the first RRC mode, and (2) processing the sensing signal to generate sensing data under the first RRC mode. The sensing apparatus may report the sensing data through Small Data Transmission (SDT) under the inactive mode

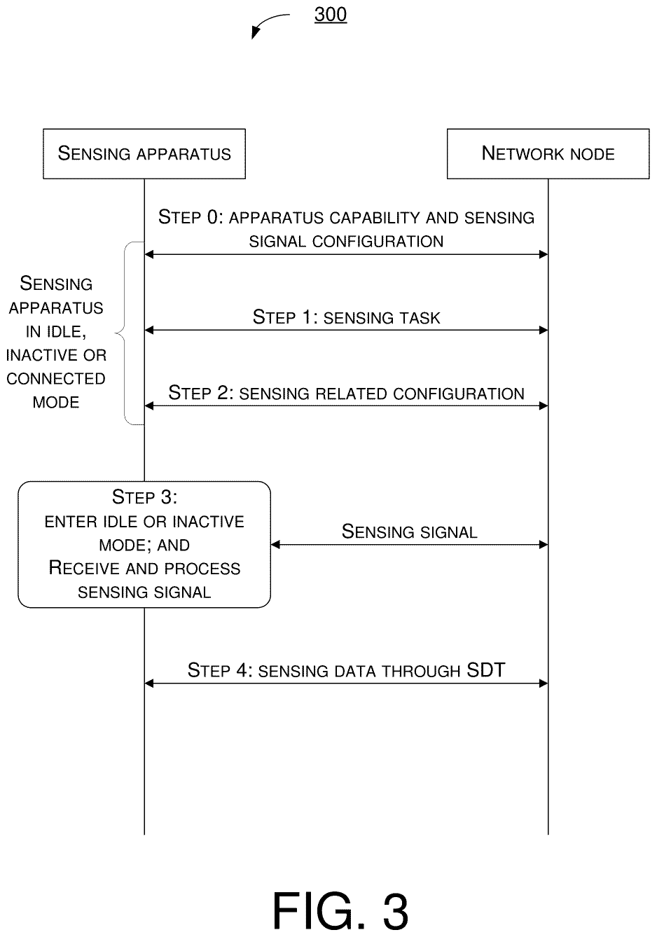

FIG. 3 illustrates an example scenario 300 under schemes in accordance with implementations of the present disclosure. In particular, there may be five main steps, which are steps 0 to 4, in a bistatic DL sensing procedure between the sensing apparatus and the network node (e.g., a UE-BS bistatic DL sensing procedure). During steps 0 to 2, the sensing apparatus may be under the idle mode, the inactive mode or the connected mode.

In step 0, the sensing apparatus may report apparatus capability and sensing signal configuration under the idle mode, the inactive mode or the connected mode. More specifically, the sensing apparatus may report to the network node that the sensing apparatus may support sensing operation in the idle mode, the inactive mode or the connected mode.

In some cases, sensing signal(s) used between the network node and the sensing apparatus may include: (1) a communication signal (e.g., SSB or TRS), or (2) a signal dedicated for sensing.

In some cases, the sensing signal(s) may be configured through SIB, RRC signaling, MAC CE, DCI, paging, PEI, etc. The sensing signal configuration may include sensing signal period, time and frequency domain pattern, BW, beam related information, etc. The sensing signal(s) may be enabled or validated (e.g., effective time) through SIB, RRC signaling, MAC CE, DCI, paging, PEI, etc. The sensing signal configuration and enabling/validation of the sensing signal may be exchanged under the idle mode, the inactive mode or the connected mode before the sensing apparatus and the network node start sensing operation.

In step 1, in an event that a sensing task is triggered by the network node, the sensing apparatus may participate in the sensing task (e.g., receiving a sensing signal, making further sensing signal processing, calculating sensing data, and reporting the sensing data). In some cases, the sensing task may involve respiration detection or intrusion detection.

In step 2, the sensing related configuration may be transceived. More specifically, the network node may: (1) configure the sensing apparatus to perform sensing operation in the idle mode, the inactive mode or the connected mode, and/or (2) configure which signal (e.g., SSB, TRS or dedicated sensing signal) the sensing apparatus may be used to perform sensing operation.

In some cases, with respect to the sensing signal configuration and enabling/validation of sensing signal, (1) validation and some additional configuration information may be configured in step 2 (while part of configurations have been configured in step 0), or (2) the sensing signal configuration and enabling/validation of sensing signal may be fully configured in step 2.

In some cases, with respect to sensing measurement and reporting related information, the network node may: (1) configure the sensing apparatus with sensing task requirements (e.g., measurement quantities, quality requirement, periodicity, etc.), (2) configure what the sensing apparatus may report, including reporting quantities, reporting value format, reporting periodicity and type (periodic, aperiodic, semi-persistent, etc.), and/or (3) configure the sensing apparatus that, if there is sensing data required to be reported to the network node, the sensing apparatus may enter the inactive mode and report the sensing data via SDT (e.g., Random Access-based SDT (RA-SDT) or Configured Grant-based SDT (CG-SDT)). In some cases, SDT-related configuration may be configured to the sensing apparatus in step 2.

In step 3, if there is no communication data transmission and reception requirement, the sensing apparatus may enter the first RRC mode which may be the inactive mode. Under the first RRC mode, the sensing apparatus may receive a sensing signal and process the sensing signal to generate sensing data. In some cases, processing the sensing signal to generate the sensing data may include: (1) using 2D-FFT or MUSIC algorithm to estimate a target's delay, Doppler, or angle information, and/or (2) calculating micro-Doppler characteristics of the sensing signal to determine the target's respiration rate.

In step 4, if the sensing apparatus needs to report the sensing data to a network node, the sensing apparatus may report the sensing data via SDT (e.g., RA-SDT or CG-SDT). The network node may receive the sensing data associated with the sensing signal through the SDT. The reporting may be performed based on the configuration and requirements of step 2. In some cases, if the sensing apparatus does not need to report the sensing data to the network node and instead reports the data to a local higher layer of the sensing apparatus (e.g., a sensing application), the sensing apparatus may not need to enter the connected mode.

In some cases, selection between RA-SDT and CG-SDT for data transmission may be determined based on the SDT configuration configured in step 2 and the characteristics of the sensing data (e.g., data size, reporting periodicity, etc.). For example, RA-SDT is used for event-triggered reporting, whereas CG-SDT is used for periodic reporting.

In some cases, if the sensing data to be reported is not suitable for transmission through SDT (e.g., when the data size is relatively large), the sensing apparatus may enter the connected mode to report the sensing data.

In some implementations, the at least one sensing configuration may be received before entering the first RRC mode. The first RRC mode may include the idle mode or the inactive mode. Performing the sensing operation may include transmitting a sensing signal under the first RRC mode.

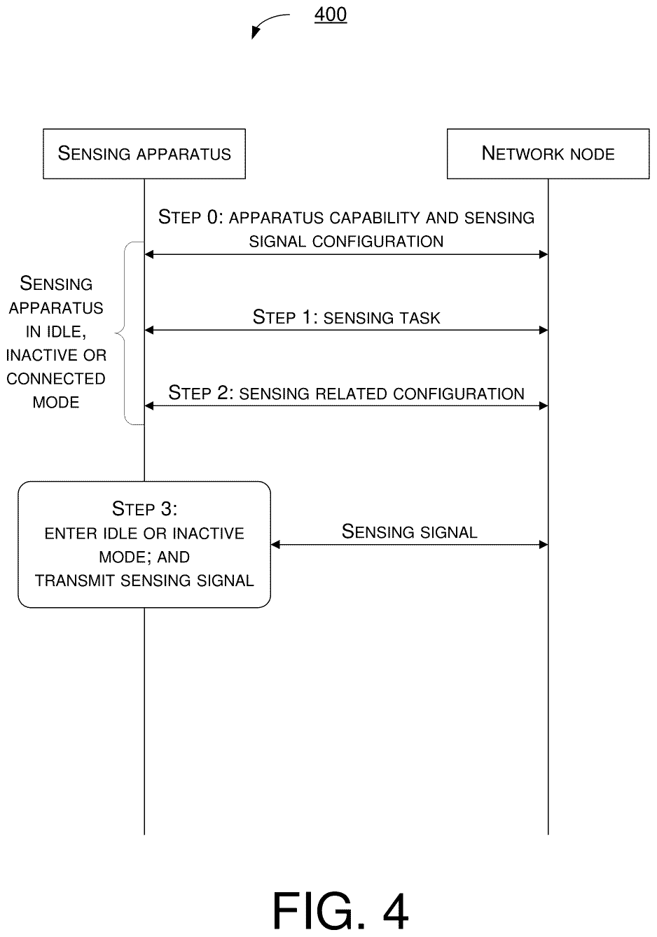

FIG. 4 illustrates an example scenario 400 under schemes in accordance with implementations of the present disclosure. In particular, there may be four main steps, which are steps 0 to 3, in a bistatic Uplink (UL) sensing procedure between the sensing apparatus and the network node (e.g., a UE-BS bistatic UL sensing procedure). During steps 0 to 2, the sensing apparatus may be under the idle mode, the inactive mode or the connected mode.

In step 0, the sensing apparatus may report apparatus capability and sensing signal configuration under the idle mode, the inactive mode or the connected mode. More specifically, the sensing apparatus may report to the network node that the sensing apparatus may support sensing operation in the idle mode, the inactive mode or the connected mode.

In step 1, in an event that a sensing task is required by the network node, the sensing apparatus may participate in the sensing task (e.g., the sensing apparatus may be a TX sensing apparatus and transmit an UL sensing signal to the network node). In some cases, the sensing task may involve respiration detection, intrusion detection, Unmanned Aerial Vehicle (UAV) detection, or sensing the environment around the sensing apparatus.

In step 2, the sensing related configuration may be transceived. More specifically, the network node may configure the sensing apparatus to perform sensing operation (e.g., transmitting the UL sensing signal) in the idle mode, the inactive mode or the connected mode.

In some cases, the UL sensing signal may be configured and indicated through RRC signaling, MAC CE, Uplink Control Information (UCI), etc. The UL sensing signal may include the UL Sounding Reference Signal (SRS) or a dedicated UL sensing signal. The sensing signal configuration may include period, time and frequency domain pattern, BW, etc. The transmission of the UL sensing signal may be aperiodic, periodic, or semi-persistent. The sensing apparatus may need to follow the configuration and indication to transmit the sensing signal in step 3.

In step 3, if there is no substantial communication data transmission and reception requirement, the sensing apparatus may enter the first RRC mode which may be the idle mode or the inactive mode. Under the first RRC mode, the sensing apparatus may transmit a sensing signal to the network node, following the configurations and indications of step 2. The network node may receive the sensing signal and process the sensing signal.

In some cases, if the sensing apparatus needs to be under the connected mode for communication traffic, the sensing operation may be performed in the connected mode and follow the configurations of sensing of the connected mode.

In some implementations, the at least one sensing configuration may be received before entering the first RRC mode. The first RRC mode may include the inactive mode. Performing the sensing operation may include transmitting a sensing signal through SDT under the first RRC mode.

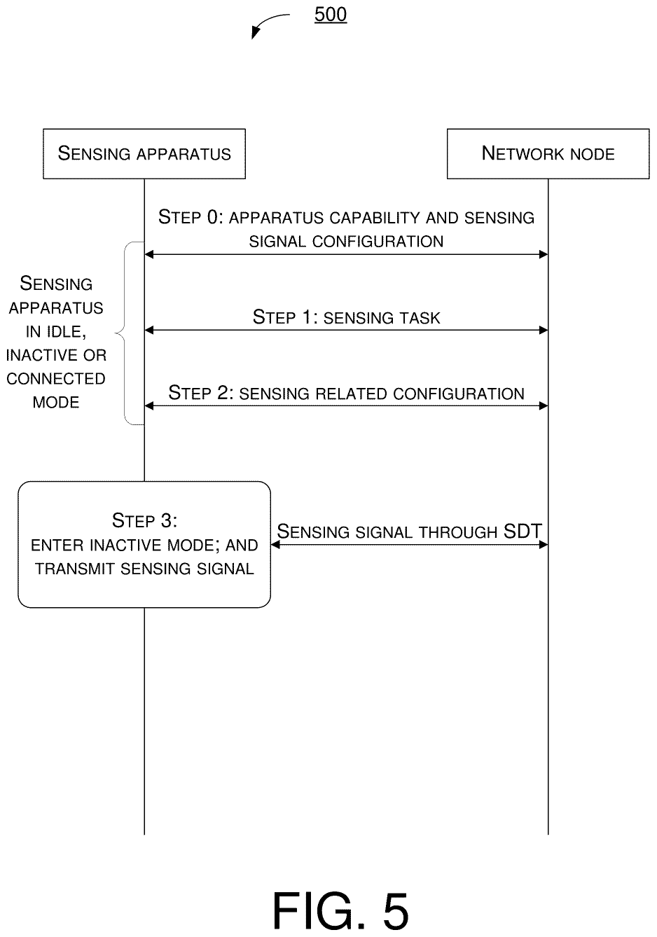

FIG. 5 illustrates an example scenario 500 under schemes in accordance with implementations of the present disclosure. In particular, there may be four main steps, which are steps 0 to 3, in a bistatic UL sensing procedure between the sensing apparatus and the network node (e.g., a UE-BS bistatic UL sensing procedure). During steps 0 to 2, the sensing apparatus may be under the idle mode, the inactive mode or the connected mode.

In step 0, the sensing apparatus may report apparatus capability and sensing signal configuration under the idle mode, the inactive mode or the connected mode. More specifically, the sensing apparatus may report to the network node that the sensing apparatus may support sensing operation in the idle mode, the inactive mode or the connected mode.

In step 1, in an event that a sensing task is triggered by the network node, the sensing apparatus may participate in the sensing task (e.g., the sensing apparatus may be a TX sensing apparatus and transmit an UL sensing signal to the network node). In some cases, the sensing task may involve respiration detection, intrusion detection, UAV detection, or sensing the environment around the sensing apparatus.

In step 2, the sensing related configuration may be transceived. More specifically, the network node may configure the sensing apparatus to perform a sensing operation under the inactive mode. The sensing apparatus may transmit a sensing signal to the network node through SDT (e.g., RA-SDT or CG-SDT) under the inactive mode.

In some cases, the UL sensing signal may be configured and indicated through RRC signaling, MAC CE, UCI, etc. The UL sensing signal may include an UL SRS or a dedicated UL sensing signal. The sensing signal configuration may include period, time and frequency domain pattern, BW, etc. The transmission of the UL sensing signal may be aperiodic, periodic, or semi-persistent. The sensing apparatus may need to follow the configuration and indication to transmit the sensing signal in step 3. SDT related configuration may be configured to sensing apparatus in step 2.

In step 3, if there is no substantial communication data transmission and reception requirement, the sensing apparatus may enter the first RRC mode which may be the inactive mode. Under the first RRC mode, the sensing apparatus may transmit a sensing signal to the network node through the SDT, following the configurations and indications of step 2. The network node may receive the sensing signal through the SDT and process the sensing signal.

In some cases, if the sensing signal is suitable to be transmitted through the SDT, the sensing apparatus may select RA-SDT or CG-SDT, which may depend on the type of sensing signal and SDT configuration in step 2. For example, if the sensing signal is associated with short periodic and small data size, the sensing apparatus uses CG-SDT for the transmission. RA-SDT is used for event-trigger reporting.

In some cases, if the sensing data to be reported is not suitable for transmission through SDT (e.g., when the data size is relatively large), the sensing apparatus may enter the connected mode to report the sensing data.

In some implementations, the at least one sensing configuration may be received before entering the first RRC mode. The first RRC mode may include the idle mode or the inactive mode. Performing the sensing operation may include: (1) receiving a sensing signal under the first RRC mode, and (2) utilizing the sensing signal for a communication operation under the first RRC mode.

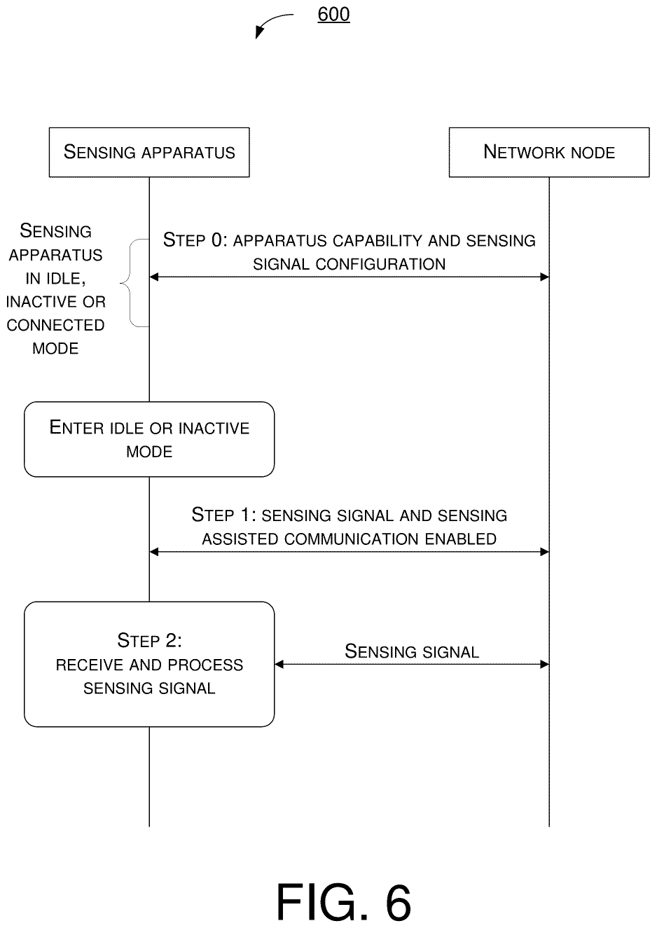

FIG. 6 illustrates an example scenario 600 under schemes in accordance with implementations of the present disclosure. In particular, there may be three main steps, which are steps 0 to 2. During step 0, the sensing apparatus may be under the idle mode, the inactive mode or the connected mode.

In step 0, the sensing apparatus may report apparatus capability and sensing signal configuration under the idle mode, the inactive mode or the connected mode. More specifically, the sensing apparatus may report to the network node that the sensing apparatus may support sensing operation in the idle mode, the inactive mode or the connected mode.

In some cases, sensing signal(s) used between the network node and the sensing apparatus may include: (1) a communication signal (e.g., Synchronization Signal Block (SSB) or Tracking Reference Signal (TRS)), or (2) a signal dedicated for sensing.

In some cases, the sensing signal(s) may be configured through SIB, RRC signaling, MAC CE, DCI, paging, PEI, etc. The sensing signal configuration may include sensing signal period, time and frequency domain pattern, BW, beam related information, etc. The sensing signal(s) may be enabled or validated (e.g., effective time) through SIB, RRC signaling, MAC CE, DCI, paging, PEI, etc. The sensing signal configuration and enabling/validation of the sensing signal may be exchanged under the idle mode, the inactive mode or the connected mode before the sensing apparatus and the network node start sensing operation. Then, the sensing apparatus may enter the first RRC mode. The first RRC mode may be the idle mode or the inactive mode.

In step 1, the sensing signal may be enabled, and the sensing assisted communication may be enabled. More specifically, with respect to the sensing signal configuration and enabling/validation of sensing signal: (1) validation and some additional configuration information may be configured in step 1 through paging or PEI (while part of configurations have been configured in step 0), or (2) the sensing signal configuration and enabling/validation of sensing signal may be fully configured in step 1.

In some cases, the network node may configure the sensing apparatus to: (1) utilize the sensing signal to obtain some channel information and assist communication (e.g., Radio Resource Management (RRM), synchronization, and/or Beam Management (BM)), or (2) utilize the sensing signal to replace other communication reference signal (e.g., SSB, TRS, etc.) to perform RRM, synchronization, and/or BM. In some cases, the network node may configure the sensing apparatus to utilize the sensing signal in step 0.

In step 2, the sensing apparatus may receive and process the sensing signal. The sensing apparatus may utilize results (obtained from processing the sensing signal) to assist RRM, synchronization and/or BM. In some cases, the sensing apparatus may receive the sensing signal without receiving a communication reference signal to perform RRM, synchronization, and/or BM.

In some implementations, the first RRC mode may include the idle mode. Performing the sensing operation may include: (1) entering a second RRC mode including the idle mode, the inactive mode or the connected mode, and (2) receiving at least one sensing configuration under the second RRC mode. The sensing operation may be performed under the second RRC mode.

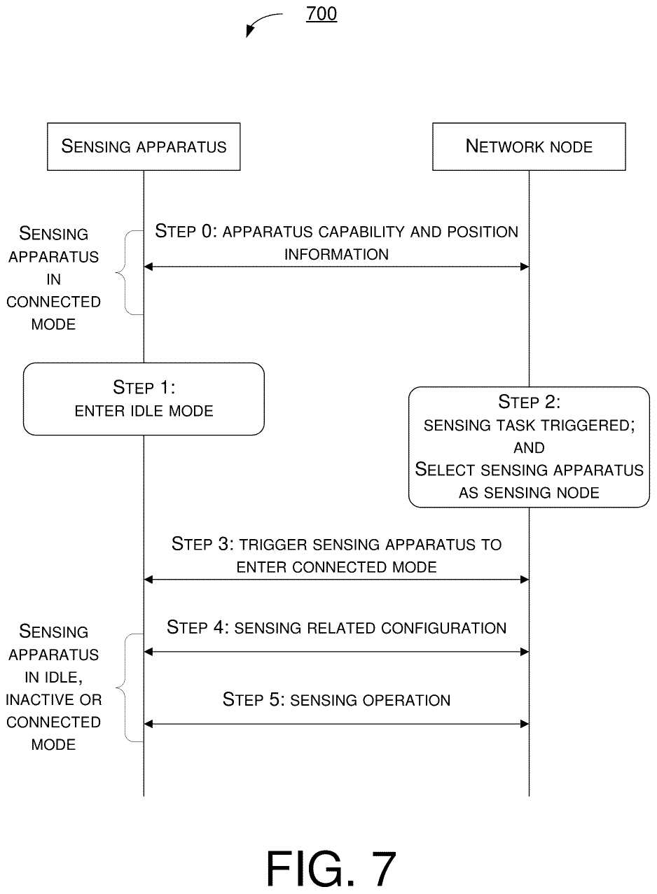

FIG. 7 illustrates an example scenario 700 under schemes in accordance with implementations of the present disclosure. In particular, there may be six main steps, which are steps 0 to 5. During step 0, the sensing apparatus may be under the connected mode.

In step 0, the sensing apparatus may report: (1) apparatus capability for sensing, and (2) position information before entering the idle mode. In particular, the sensing apparatus may report the apparatus's capability and indicate its readiness to serve as a sensing node. The sensing apparatus may be a candidate sensing node if there is an associated sensing task. The position information may also be reported to the network node.

In some cases, the sensing apparatus may ensure that the sensing apparatus may remain stationary in the idle mode and stay within the coverage of the current cell. In some cases, the apparatus capability and position information may be reported during an RRC release stage.

In step 1, the sensing apparatus may enter the first RRC mode. The RRC mode may be the idle mode.

In step 2, a sensing task may be triggered in the network node, and the network node may select the sensing apparatus as the sensing node.

In step 3, the network node may trigger the sensing apparatus to enter the connected mode through paging. The sensing apparatus may perform some operations under the connected mode. Then, the sensing apparatus may enter the second RRC mode. The second RRC mode may be the idle mode, the inactive or the connected mode.

In step 4, the sensing related configuration may be transceived. More specifically, the network node may configure the sensing apparatus to perform a sensing operation under the second RRC mode. The sensing apparatus may receive the sensing related configuration under the second RRC mode.

In step 5, the sensing apparatus and the network node may perform corresponding sensing operation under the second RRC mode.

In some implementations, the first RRC mode may include the connected mode. Performing the sensing operation may include transmitting or receiving a sensing signal (e.g., UL sensing signal or DL sensing signal) during a Connected Mode Discontinuous Reception (CDRX) on-duration.

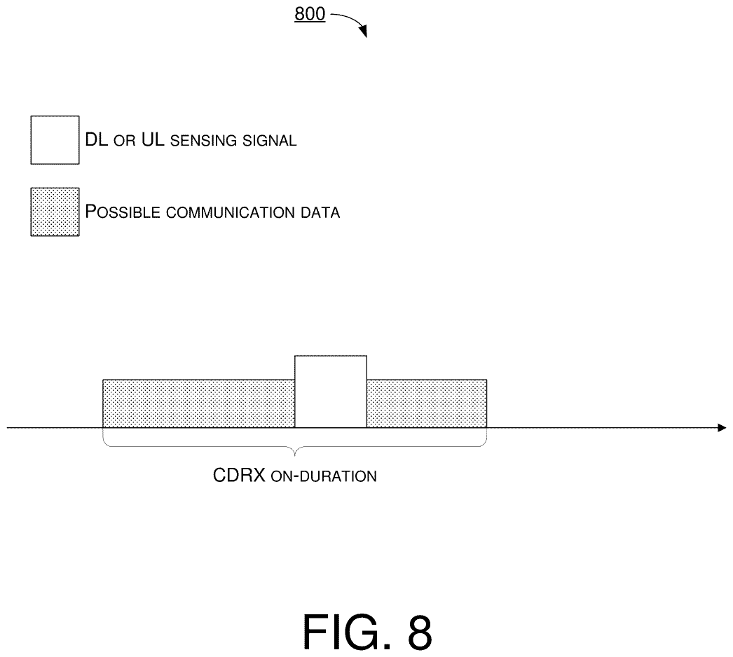

FIG. 8 illustrates an example scenario 800 under schemes in accordance with implementations of the present disclosure. In some cases, the network node may configure the sensing apparatus to transmit the UL sensing signal during CDRX on-duration (may have communication data transmission). In some cases, the network node may configure the sensing apparatus to receive the DL sensing signal during CDRX on-duration.

In some implementations, the first RRC mode may include the connected mode. Performing the sensing operation may include: (1) receiving a sensing signal (e.g., DL sensing signal) during a CDRX off-duration, processing the sensing signal to generate sensing data, and (3) reporting the sensing data during a CDRX on-duration.

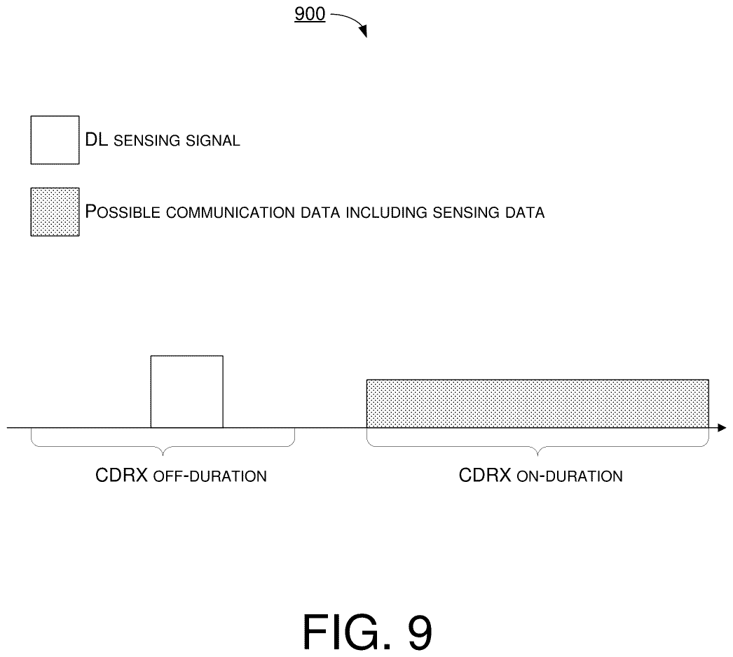

FIG. 9 illustrates an example scenario 900 under schemes in accordance with implementations of the present disclosure. In some cases, the network node may configure the sensing apparatus to receive the DL sensing signal in the CDRX off-duration. The sensing apparatus may receive the DL sensing signal in off-duration and process the DL sensing signal to generate sensing data. In some cases, reporting the sensing data may follow the rule of communication UL data transmission in CDRX (e.g., the sensing data may be reported in the next CDRX on-duration).

### Illustrative Implementations

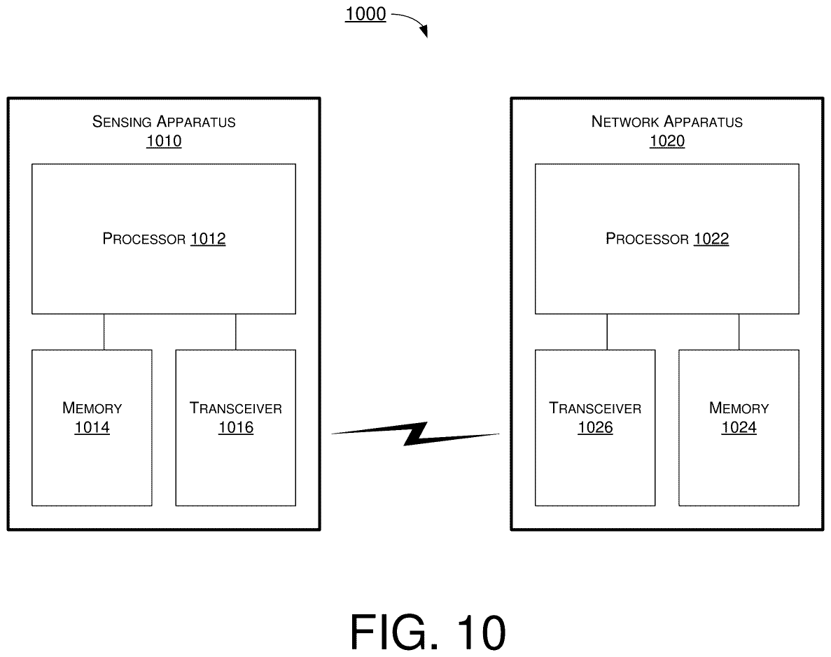

FIG. 10 illustrates an example ISAC system 1000 having an example sensing apparatus 1010 and an example network apparatus 1020 in accordance with an implementation of the present disclosure. Each of sensing apparatus 1010 and network apparatus 1020 may perform various functions to implement schemes, techniques, processes and methods described herein pertaining to performing sensing operation under various RRC modes with respect to UE and network apparatus in mobile communications, including scenarios/schemes described above as well as processes 1100 and 1200 described below.

Sensing apparatus 1010 may be: (1) a part of an electronic apparatus, which may be a UE such as a portable or mobile apparatus, a wearable apparatus, a wireless communication apparatus or a computing apparatus, or (2) a part of a network apparatus, which may be a network node such as a satellite, a base station, a small cell, a router or a gateway. For instance, sensing apparatus 1010 may be implemented in a smartphone, a smartwatch, a personal digital assistant, a digital camera, or a computing equipment such as a tablet computer, a laptop computer or a notebook computer. Sensing apparatus 1010 may also be a part of a machine type apparatus, which may be an IoT, NB-IoT, or IIoT apparatus such as an immobile or a stationary apparatus, a home apparatus, a wire communication apparatus or a computing apparatus. For instance, sensing apparatus 1010 may be implemented in a smart thermostat, a smart fridge, a smart door lock, a wireless speaker or a home control center. For instance, sensing apparatus 1010 may be implemented in an eNodeB in an LTE network, in a gNB in a 5G/NR, IoT, NB-IoT or IIoT network or in a satellite or base station in a 6G network. Alternatively, sensing apparatus 1010 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Sensing apparatus 1010 may include at least some of those components shown in FIG. 10 such as a processor 1012, for example. Sensing apparatus 1010 may further include one or more other components not pertinent to the proposed scheme of the present disclosure (e.g., internal power supply, display device and/or user interface device), and, thus, such component(s) of apparatus 1010 are neither shown in FIG. 10 nor described below in the interest of simplicity and brevity.

It should be noted that sensing apparatus 1010 may include a sensing TX and/or a sensing RX. For ease of illustration, only a single sensing apparatus 1010 is depicted in FIG. 10, and such depiction is not intended to limit the scope of the present disclosure. A person skilled in the art should readily understand that, in a bistatic sensing system, two sensing apparatuses 1010 may be employed, respectively functioning as a sensing TX and a sensing RX.

Network apparatus 1020 may be a part of a network apparatus, which may be a network node such as a satellite, a base station, a small cell, a router or a gateway. For instance, network apparatus 1020 may be implemented in an eNodeB in an LTE network, in a gNB in a 5G/NR, IoT, NB-IoT or IIoT network or in a satellite or base station in a 6G network. Alternatively, network apparatus 1020 may be implemented in the form of one or more IC chips such as, for example and without limitation, one or more single-core processors, one or more multi-core processors, or one or more RISC or CISC processors. Network apparatus 1020 may include at least some of those components shown in FIG. 10 such as a processor 1022, for example. Network apparatus 1020 may further include one or more other components not pertinent to the proposed scheme of the present disclosure (e.g., internal power supply, display device and/or user interface device), and, thus, such component(s) of network apparatus 1020 are neither shown in FIG. 10 nor described below in the interest of simplicity and brevity.

In one aspect, each of processor 1012 and processor 1022 may be implemented in the form of one or more single-core processors, one or more multi-core processors, or one or more CISC processors. That is, even though a singular term “a processor” is used herein to refer to processor 1012 and processor 1022, each of processor 1012 and processor 1022 may include multiple processors in some implementations and a single processor in other implementations in accordance with the present disclosure. In another aspect, each of processor 1012 and processor 1022 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1012 and processor 1022 is a special-purpose machine specifically designed, arranged and configured to perform specific tasks including performing sensing operation under various RRRC modes in a device (e.g., as represented by communication apparatus 1010) and a network (e.g., as represented by network apparatus 1020) in accordance with various implementations of the present disclosure.

In some implementations, sensing apparatus 1010 may also include a transceiver 1016 coupled to processor 1012 and capable of wirelessly transmitting and receiving data. In other words, processor 1012 may transceive the data such as configuration, message, signal, information, indicator, etc. via transceiver 1016. In some implementations, sensing apparatus 1010 may further include a memory 1014 coupled to processor 1012 and capable of being accessed by processor 1012 and storing data therein. In some implementations, network apparatus 1020 may also include a transceiver 1026 coupled to processor 1022 and capable of wirelessly transmitting and receiving data. In other words, processor 1022 may transceive the data such as configuration, message, signal, information, indicator, etc. via transceiver 1026. In some implementations, network apparatus 1020 may further include a memory 1024 coupled to processor 1022 and capable of being accessed by processor 1022 and storing data therein. Accordingly, sensing apparatus 1010 and network apparatus 1020 may wirelessly communicate with each other via transceiver 1016 and transceiver 1026, respectively. To aid better understanding, the following description of the operations, functionalities and capabilities of each of sensing apparatus 1010 and network apparatus 1020 is provided in the context of a mobile communication environment in which sensing apparatus 1010 is implemented in or as a communication apparatus, a UE, or a network node (e.g., BS or CN), and network apparatus 1020 is implemented in or as a network node of a communication network.

In some implementations, each of memory 1014 and memory 1024 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1014 and memory 1024 may include a type of read-only memory (ROM) such as mask ROM, programmable ROM (PROM), erasable programmable ROM (EPROM) and/or electrically erasable programmable ROM (EEPROM). Alternatively, or additionally, each of memory 1014 and memory 1024 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

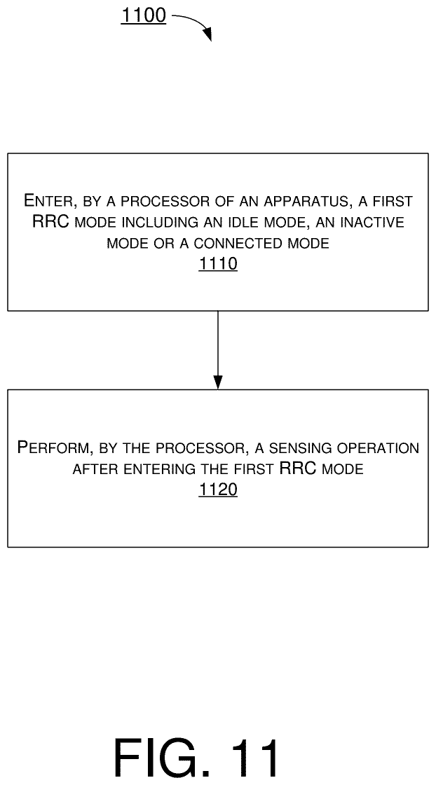

FIG. 11 illustrates an example process 1100 in accordance with an implementation of the present disclosure. Process 1100 may be an example implementation of above scenarios/schemes, whether partially or completely, with respect to performing sensing operation under various RRC modes of the present disclosure. Process 1100 may represent an aspect of implementation of features of sensing apparatus 1010. Process 1100 may include one or more operations, actions, or functions as illustrated by one or more of blocks 1110 and 1120. Although illustrated as discrete blocks, various blocks of process 1100 may be divided into additional blocks, combined into fewer blocks, or eliminated, depending on the desired implementation. Moreover, the blocks of process 1100 may be executed in the order shown in FIG. 11 or, alternatively, in a different order. Process 1100 may be implemented by sensing apparatus 1010 or any suitable UE, network devices or machine type devices. Solely for illustrative purposes and without limitation, process 1100 is described below in the context of sensing apparatus 1010. Process 1100 may begin at block 1110.

At block 1110, process 1100 may involve processor 1012 of sensing apparatus 1010 entering a first RRC mode including an idle mode, an inactive mode or a connected mode. Process 1100 may proceed from block 1110 to block 1120.

At block 1120, process 1100 may involve processor 1012 of sensing apparatus 1010 performing a sensing operation after entering the first RRC mode.

In some implementations, at least one sensing configuration may be received before entering the first RRC mode. The first RRC mode may include the idle mode or the inactive mode. Performing the sensing operation may further include: (1) receiving a sensing signal under the first RRC mode; and (2) processing the sensing signal to generate sensing data under the first RRC mode. Process 1100 may further involve processor 1012 of sensing apparatus 1010 entering a second RRC mode including the connected mode. Process 1100 may further involve processor 1012 of sensing apparatus 1010 reporting the sensing data.

In some implementations, at least one sensing configuration may be received before entering the first RRC mode. The first RRC mode may include the inactive mode. Performing the sensing operation may further include: (1) receiving a sensing signal under the first RRC mode; and (2) processing, by the processor, the sensing signal to generate sensing data under the first RRC mode. Process 1100 may further involve processor 1012 of sensing apparatus 1010 reporting the sensing data through SDT.

In some implementations, at least one sensing configuration may be received before entering the first RRC mode. The first RRC mode may include the idle mode or the inactive mode. Performing the sensing operation may further include: transmitting a sensing signal under the first RRC mode.

In some implementations, the first RRC mode may include the inactive mode. Performing the sensing operation may further include: transmitting a sensing signal through SDT under the first RRC mode.

In some implementations, at least one sensing configuration may be received before entering the first RRC mode. The first RRC mode may include the idle mode or the inactive mode. Performing the sensing operation may further include: (1) receiving a sensing signal under the first RRC mode; and (2) utilizing the sensing signal for a communication operation under the first RRC mode.

In some implementations, the first RRC mode may include the idle mode. Process 1100 may further involve processor 1012 of sensing apparatus 1010 entering a second RRC mode including the idle mode, the inactive mode or the connected mode. Process 1100 may further involve processor 1012 of sensing apparatus 1010 receiving at least one sensing configuration under the second RRC mode. The sensing operation may be performed under the second RRC mode.

In some implementations, the first RRC mode may include the connected mode. Performing the sensing operation may further include: transmitting or receiving a sensing signal during a CDRX on-duration.

In some implementations, the first RRC mode may include the connected mode. Performing the sensing operation may further include: (1) receiving a sensing signal during a CDRX off-duration; (2) processing the sensing signal to generate sensing data; and (3) reporting the sensing data during a CDRX on-duration.

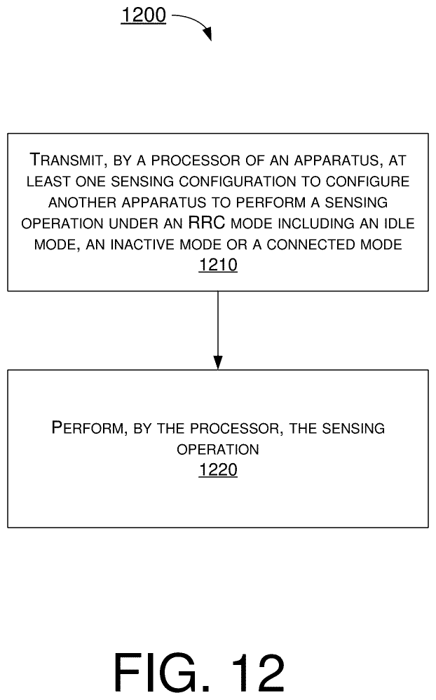

FIG. 12 illustrates an example process 1200 in accordance with an implementation of the present disclosure. Process 1200 may be an example implementation of above scenarios/schemes, whether partially or completely, with respect to performing sensing operation under various RRC modes of the present disclosure. Process 1200 may represent an aspect of implementation of features of network apparatus 1020. Process 1200 may include one or more operations, actions, or functions as illustrated by one or more of blocks 1210 and 1220. Although illustrated as discrete blocks, various blocks of process 1200 may be divided into additional blocks, combined into fewer blocks, or eliminated, depending on the desired implementation. Moreover, the blocks of process 1200 may be executed in the order shown in FIG. 12 or, alternatively, in a different order. Process 1200 may be implemented by network apparatus 1020 or any suitable network device or machine type devices. Solely for illustrative purposes and without limitation, process 1200 is described below in the context of network apparatus 1020. Process 1200 may begin at block 1210.

At block 1210, process 1200 may involve processor 1022 of network apparatus 1020 transmitting at least one sensing configuration to configure another apparatus (e.g., sensing apparatus 1010) to perform a sensing operation under an RRC mode including an idle mode, an inactive mode or a connected mode. Process 1200 may proceed from block 1210 to block 1220.

At block 1220, process 1200 may involve processor 1022 of network apparatus 1020 performing the sensing operation.

In some implementations, the RRC mode may include the idle mode or the inactive mode. Performing the sensing operation may further include: (1) transmitting a sensing signal; and (2) receiving a sensing data associated with the sensing signal.

In some implementations, the RRC mode may include the inactive mode. Performing the sensing operation may further include: (1) transmitting a sensing signal; and (2) receiving a sensing data associated with the sensing signal through SDT.

In some implementations, the RRC mode may include the idle mode or the inactive mode. Performing the sensing operation may further include: (1) receiving a sensing signal; and (2) processing the sensing signal.

In some implementations, the RRC mode may include the inactive mode. Performing the sensing operation may further include: receiving a sensing signal through SDT.

In some implementations, the RRC mode may include the idle mode or the inactive mode. The at least one sensing configuration may further configure to utilize a sensing signal for a communication operation. Performing the sensing operation may further include: (1) transmitting the sensing signal.

In some implementations, process 1200 may further involve processor 1022 of network apparatus 1020 selecting the another apparatus as a sensing node. Process 1200 may further involve processor 1022 of network apparatus 1020 triggering the another apparatus to enter the connected mode.

In some implementations, the RRC mode may include the connected mode. Performing the sensing operation may further include: transmitting or receiving a sensing signal during a CDRX on-duration.

In some implementations, the RRC mode may include the connected mode. Performing the sensing operation may further include: (1) transmitting a sensing signal during a CDRX off-duration; and (2) receiving a sensing data associated with the sensing signal during a CDRX off-duration.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
entering, by a processor of an apparatus, a first Radio Resource Control (RRC) mode including an idle mode, an inactive mode or a connected mode; and
performing, by the processor, a sensing operation after entering the first RRC mode.

2. The method of claim 1, wherein at least one sensing configuration is received before entering the first RRC mode, the first RRC mode includes the idle mode or the inactive mode, and the performing of the sensing operation further comprises:
receiving, by the processor, a sensing signal under the first RRC mode; and
processing, by the processor, the sensing signal to generate sensing data under the first RRC mode,
wherein the method further comprises:
entering, by the processor, a second RRC mode including the connected mode; and
reporting, by the processor, the sensing data.

3. The method of claim 1, wherein at least one sensing configuration is received before entering the first RRC mode, the first RRC mode includes the inactive mode, and the performing of the sensing operation further comprises:
receiving, by the processor, a sensing signal under the first RRC mode; and
processing, by the processor, the sensing signal to generate sensing data under the first RRC mode,
wherein the method further comprises:
reporting, by the processor, the sensing data through Small Data Transmission (SDT).

4. The method of claim 1, wherein at least one sensing configuration is received before entering the first RRC mode, the first RRC mode includes the idle mode or the inactive mode, and the performing of the sensing operation further comprises:
transmitting, by the processor, a sensing signal under the first RRC mode.

5. The method of claim 1, wherein the first RRC mode includes the inactive mode, and the performing of the sensing operation further comprises:
transmitting, by the processor, a sensing signal through Small Data Transmission (SDT) under the first RRC mode.

6. The method of claim 1, wherein at least one sensing configuration is received before entering the first RRC mode, the first RRC mode includes the idle mode or the inactive mode, and the performing of the sensing operation further comprises:
receiving, by the processor, a sensing signal under the first RRC mode; and
utilizing, by the processor, the sensing signal for a communication operation under the first RRC mode.

7. The method of claim 1, wherein the first RRC mode includes the idle mode, and the method further comprises:
entering, by the processor, a second RRC mode including the idle mode, the inactive mode or the connected mode; and
receiving, by the processor, at least one sensing configuration under the second RRC mode,
wherein the sensing operation is performed under the second RRC mode.

8. The method of claim 1, wherein the first RRC mode includes the connected mode, and the performing of the sensing operation further comprises:
transmitting or receiving, by the processor, a sensing signal during a Connected Mode Discontinuous Reception (CDRX) on-duration.

9. The method of claim 1, wherein the first RRC mode includes the connected mode, and the performing of the sensing operation further comprises:
receiving, by the processor, a sensing signal during a Connected Mode Discontinuous Reception (CDRX) off-duration;
processing, by the processor, the sensing signal to generate sensing data; and
reporting, by the processor, the sensing data during a CDRX on-duration.

10. A method, comprising:
transmitting, by a processor of an apparatus, at least one sensing configuration to configure another apparatus to perform a sensing operation under a Radio Resource Control (RRC) mode including an idle mode, an inactive mode or a connected mode; and
performing, by the processor, the sensing operation.

11. The method of claim 10, wherein the RRC mode includes the idle mode or the inactive mode, and the performing of the sensing operation further comprises:
transmitting, by the processor, a sensing signal; and
receiving, by the processor, a sensing data associated with the sensing signal.

12. The method of claim 10, wherein the RRC mode includes the inactive mode, and the performing of the sensing operation further comprises:
transmitting, by the processor, a sensing signal; and
receiving, by the processor, sensing data associated with the sensing signal through Small Data Transmission (SDT).

13. The method of claim 10, wherein the RRC mode includes the idle mode or the inactive mode, and the performing of the sensing operation further comprises:
receiving, by the processor, a sensing signal; and
processing, by the processor, the sensing signal.

14. The method of claim 10, wherein the RRC mode includes the inactive mode, and the performing of the sensing operation further comprises:
receiving, by the processor, a sensing signal through Small Data Transmission (SDT).

15. The method of claim 10, wherein the RRC mode includes the idle or the inactive mode, the at least one sensing configuration further configures to utilize a sensing signal for a communication operation, and the performing of the sensing operation further comprises:
transmitting, by the processor, the sensing signal.

16. The method of claim 10, further comprising:
selecting, by the processor, the another apparatus as a sensing node; and
triggering, by the processor, the another apparatus to enter the connected mode.

17. The method of claim 10, wherein the RRC mode includes the connected mode, and the performing of the sensing operation further comprises:
transmitting or receiving, by the processor, a sensing signal during a Connected Mode Discontinuous Reception (CDRX) on-duration.

18. The method of claim 10, wherein the RRC mode includes the connected mode, and the performing of the sensing operation further comprises:
transmitting, by the processor, a sensing signal during a Connected Mode Discontinuous Reception (CDRX) off-duration; and
receiving, by the processor, sensing data associated with the sensing signal during a CDRX off-duration.

19. An apparatus, comprising:
a transceiver which, during operation, wirelessly communicates with a wireless network; and
a processor communicatively coupled to the transceiver such that, during operation, the processor performs operations comprising:
entering a Radio Resource Control (RRC) mode including an idle mode, an inactive mode or a connected mode; and
performing a sensing operation after entering the RRC mode.

20. The apparatus of claim 19, wherein, during operation, the processor further performs operations comprising:
receiving, via the transceiver, at least one sensing configuration associated with the sensing operation under the RRC mode.
